(19) United States
(12) Patent Application Publication
(10) Pub. No.: US 2005/0104557 A1
(43) Pub. Date: May 19, 2005

(54) Multifunction car charger connector

(76) Inventor: Ta-Shuo Chang, Taipei (TW)

Correspondence Address: TA-SHUO CHANG, P.O. BOX 24-108, TAIPEI, TW

(21) Appl. No.: 10/715,188

(22) Filed: Nov. 18, 2003

(51) Int. Cl. H02J 7/02

(52) U.S. Cl. 320/111

(57) ABSTRACT

A multifunction car charger connector compromising a pedestal and a backup battery charging body. The pedestal has a charger connector connects to the cigarette lighter of the automobile and forms a charging and handsfree circuit internally for mobile phones, PDA's or handheld games, a circuit board is installed on the converter base of the pedestal; a plug-in slot is on the converter base for a charging circuitry to fit in and connect to the backup battery charging body for the backup batteries, the batteries connects to the circuit inside the pedestal through the charging circuitry and a conductor slice. A plug base is on the pedestal to connect to mobile phones, PDA's or handheld games with an extension cable.

### BACKGROUND OF THE INVENTION

I. Field of the Invention

This invention relates generally to a car charger connector and, more specifically, to a multifunction car charger connector that plugs in the cigarette lighter of an automobile and connect to the circuit board inside the charger, a converter is installed inside to charge batteries and carry out handsfree functions of mobiles phone, PDA's and hand held games connected. An attachment with charging circuit for backup batteries to charge can connect to the car charger circuit, plugs for mobiles phone, PDA's and hand held games can also connect to the cigarette lighter through internal circuit. The present invention not only charge batteries and carry out handsfree functions of mobiles phone, PDA's and hand held games connected, also charge backup batteries.

II. Description of the Prior Art

Heretofore, it is known that mobile phones, PDA's and hand held video games are getting more and more popular; these appliances are very convenient for people while they go outdoors. Most of the automobiles have a charger and a converter for battery charging and handsfree functions. However most of those converters are designed for single function; with the limited number of cigarette lighter inside an automobile, other appliances are not available without power. With only a single power charger and limited space inside an automobile is not enough for all the appliances, an apparatus is needed to have everything in order.

### SUMMARY OF THE INVENTION

It is therefore a primary object of the invention to provide a multifunction car charger connector compromising a pedestal and a backup battery charging body. The pedestal has a charger connector connects to the cigarette lighter of the automobile and forms a charging and handsfree circuit internally for mobile phones, PDA's or handheld games, a circuit board is installed on the converter base of the pedestal; a plug-in slot is on the converter base for a charging circuitry to fit in and connect to the backup battery charging body for the backup batteries, the batteries connects to the circuit inside the pedestal through the charging circuitry and a conductor slice. A plug base is on the pedestal to connect to mobile phones, PDA's or handheld games with an extension cable.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view the of the pedestal of the present invention;

FIG. 2 is an assembly view of the present invention.

FIG. 3 is a perspective view of another application in accordance with the present invention;

FIG. 4 is an assembly view of another application in accordance with the present invention;

FIG. 5 is a cross-sectional view of another embodiment of the present invention.

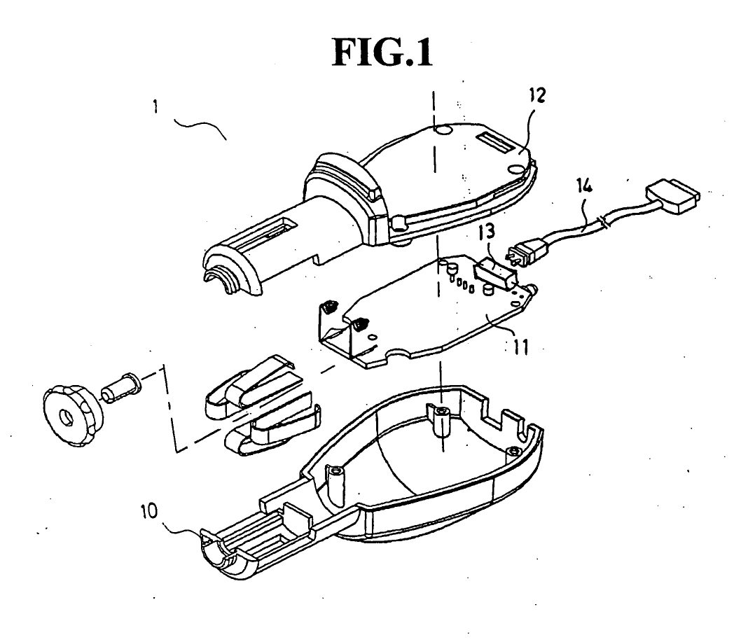

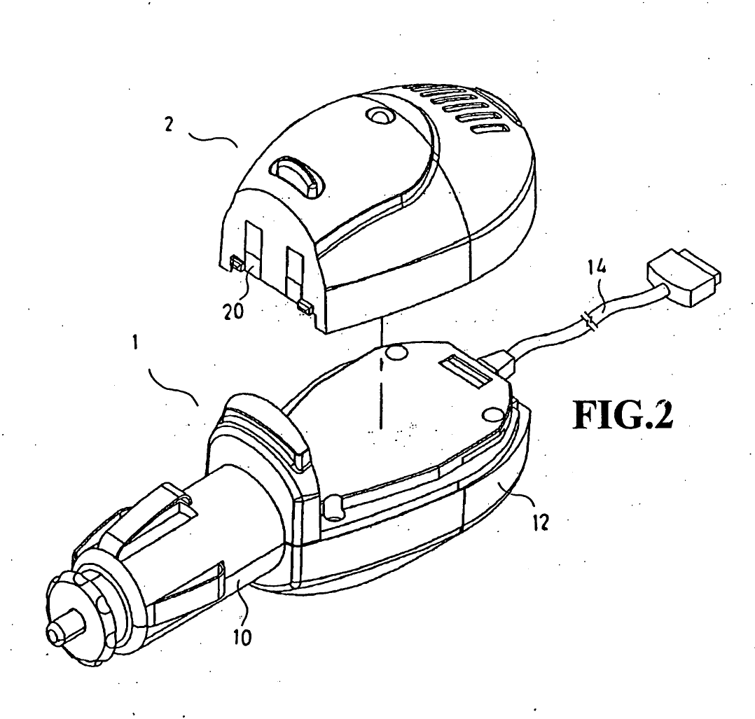

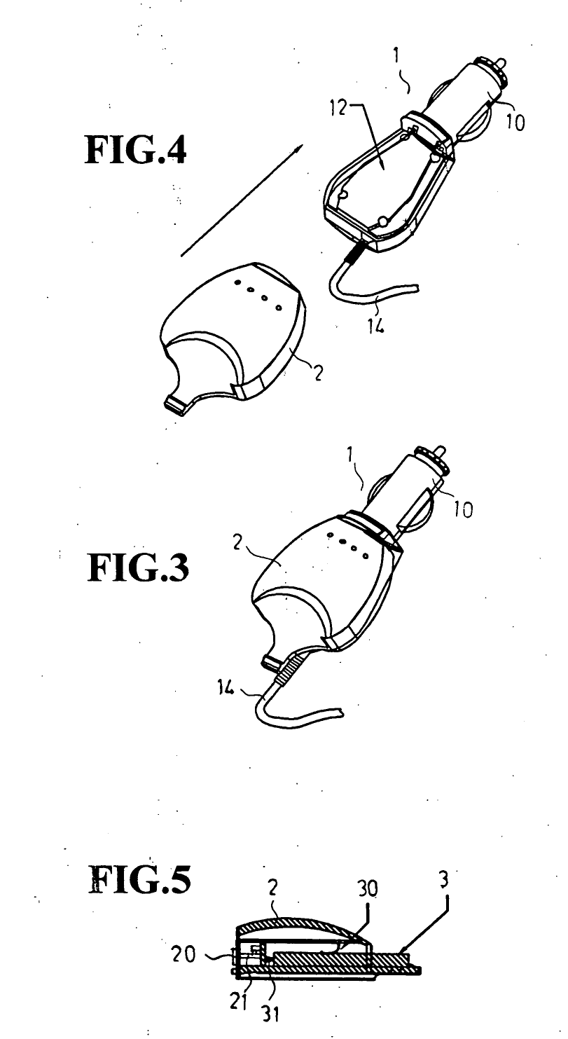

### DESCRIPTION OF THE PREFERRED EMBODIMENT

The present invention is composed of a pedestal (1) and a backup battery charging body (2). The pedestal (1) is a body that has a charger connector (10) connects to the cigarette lighter of the automobile and forms a charging and handsfree circuit internally for mobile phones, PDA's or handheld games, a circuit board (1) is installed on the converter base (12) of the pedestal (1); a plug-in slot is on the converter base (12) for a charging circuitry (21) to fit in and connect to the backup battery charging body (2) for the backup battery (3), the battery (3) connects to the circuit inside the pedestal (1) through the charging circuitry (21) and a conductor slice (20). A plug base (13) is on the pedestal (1) to connect to mobile phones, PDA's or handheld games with an extension cable (14). The backup battery charging body (2) can be made in different specifications base on the physical sizes, formats and voltages for different battery (3) to plug in.

In real application, users can plug in and fix the pedestal (1) to the automobile cigarette lighter with the charger connector (10) to connect to the internal circuit of the automobile; when users want to charge mobile phones, PDA's or handheld games and apply handsfree functions, users can have the extension cable (14) plug into the plug base (13) and connect the mobile phones, PDA's or handheld games to the pedestal (1), through the control and output of the circuit board (11) of the pedestal (1) the appliances can be charged, the handsfree functions can be applied; users can plug in the backup battery charging body (2) onto the converter base (12) of the pedestal (1), backup battery (3) are plugged in the backup battery charging body (2), battery (3) are fixed with the spring (30) and conducting slice (31), the conductor slice (20) connects to the internal circuit of the pedestal (1), the backup battery charging body (2) charges the battery (3) through the charging circuitry (21) to avoid the annoyance of insufficient plug and disorder of these appliances inside.

The structure and equipment of the present invention is not seen on the market place, the present invention not only increases the functions of car charger but also avoid the insufficient plug and too many appliances that causes disorder. While a preferred embodiment of the invention has been shown and described in detail, it will be readily understood and appreciated that numerous omissions, changes and additions may be made without departing from the spirit and scope of the invention.

1. A multifunction car charger connector comprising:
a pedestal having a charger connector connects to the cigarette lighter of the automobile and forms a charging and handsfree circuit internally to said pedestal for mobile phones, PDA's or handheld games, a circuit board is installed on the converter base of said pedestal;
a backup battery charging body with a charging circuitry for the backup battery, a plug-in slot is on said converter base for said charging circuitry to fit in and connect to said backup battery charging body, the batteries connects to the circuit inside said pedestal through said charging circuitry and a conductor slice.

2. The multifunction car charger connector recited in claim 1, wherein a plug base is on said pedestal to connect to mobile phones, PDA's or handheld games with an extension cable.

3. The multifunction car charger connector recited in claim 1 or 2, wherein said backup battery charging body being made in different specifications base on the physical sizes, formats and voltages for different batteries to plug in.
